(19) United States
(12) Patent Application Publication
(10) Pub. No.: US 2025/0234335 A1
(43) Pub. Date: Jul. 17, 2025

(54) RESOURCE ALLOCATION OF SIGNALS FOR SYNCHRONIZATION AND BEAM ACQUISITION

(71) Applicant: Samsung Electronics Co., Ltd., Suwon-si (KR)

(72) Inventors: Emad Nader Farag, Flanders, NJ (US); Eko Onggosanusi, Coppell, TX (US); Aristides Papasakellariou, Houston, TX (US)

(21) Appl. No.: 19/004,045

(22) Filed: Dec. 27, 2024

Related U.S. Application Data
(60) Provisional application No. 63/620,070, filed on Jan. 11, 2024.
(60) Provisional application No. 63/622,996, filed on Jan. 19, 2024.
(60) Provisional application No. 63/637,768, filed on Apr. 23, 2024.

(51) Int. Cl. H04W 72/02; H04B 7/06; H04W 16/28; H04W 74/0833

(52) U.S. Cl. CPC H04W 72/02; H04B 7/0626; H04W 16/28; H04W 74/0833

(57) ABSTRACT

Apparatuses and methods for resource allocation of signals for energy-efficient synchronization and beam acquisition. A method performed by a user equipment includes receiving first one or more communication elements from a first cell, determining resources for a second communication element based on information in the first one or more communication elements, and transmitting the second communication element based on the determined resources. The method further includes receiving, after a time T from the second communication element, third one or more communication elements from a second cell and identifying a spatial domain filter for reception from the second cell and a spatial domain filter for transmission to the second cell based on the third one or more communication elements. The third one or more communication elements and the time T are based on information from the first cell.

### CROSS-REFERENCE TO RELATED AND CLAIM OF PRIORITY

The present application claims priority under 35 U.S.C. § 119(e) to U.S. Provisional Patent Application No. 63/620,070 filed on Jan. 11, 2024; U.S. Provisional Patent Application No. 63/622,996 filed on Jan. 19, 2024; and U.S. Provisional Patent Application No. 63/637,768 filed on Apr. 23, 2024, which are hereby incorporated by reference in their entirety.

### TECHNICAL FIELD

The present disclosure relates generally to wireless communication systems and, more specifically, the present disclosure is related to a method and apparatus for resource allocation of signals for energy-efficient synchronization and beam acquisition.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a method and apparatus for resource allocation of signals for energy-efficient synchronization and beam acquisition.

In one embodiment, a user equipment (UE) is provided. The UE includes a transceiver configured to receive first one or more communication elements from a first cell and a processor operably coupled to the transceiver. The processor is configured to determine resources for a second communication element based on information in the first one or more communication elements. The transceiver is further configured to transmit the second communication element based on the determined resources and receive, after a time T from the second communication element, third one or more communication elements from a second cell. The third one or more communication elements and the time T are based on information from the first cell. The processor is further configured to identify a spatial domain filter for reception from the second cell and a spatial domain filter for transmission to the second cell based on the third one or more communication elements.

In another embodiment a base station (BS) is provided. The BS includes a transceiver configured to transmit first one or more communication elements from a first cell and receive a second communication element. The first one or more communication elements include information about the second communication element and a time T. The BS further includes a processor operably coupled to the transceiver. The processor is configured to determine resources for third one or more communication elements, from a second cell, based on information in the second communication element. The transceiver is further configured to transmit, based on the determined resources, the third one or more communication elements the time T from the second communication.

In yet another embodiment, a method of operating a UE is provided. The method includes receiving first one or more communication elements from a first cell, determining resources for a second communication element based on information in the first one or more communication elements, and transmitting the second communication element based on the determined resources. The method further includes receiving, after a time T from the second communication element, third one or more communication elements from a second cell and identifying a spatial domain filter for reception from the second cell and a spatial domain filter for transmission to the second cell based on the third one or more communication elements. The third one or more communication elements and the time T are based on information from the first cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example beam operation in a wireless communication system according to embodiments of the present disclosure;

FIG. 5B illustrates an example multi-beam operation in a wireless communication system according to embodiments of the present disclosure;

FIG. 6 illustrates an example of a transmitter structure for beamforming according to embodiments of the present disclosure;

FIG. 7 illustrates an example of signals and a channel for performing a cell search procedure according to embodiments of the present disclosure;

FIG. 8 illustrates a type-1 random access procedure in a wireless communication system according to embodiments of the present disclosure;

FIG. 9 illustrates a type-2 random access procedure in a wireless communication system according to embodiments of the present disclosure;

FIG. 10 illustrates an example BS or TRP operation in a wireless communication system according to embodiments of the present disclosure;

FIG. 11 illustrates an example signal transmission procedure in a wireless communication system according to embodiments of the present disclosure;

FIGS. 12A-12D illustrate example signal structures for a signal transmitted in a wireless communication system according to embodiments of the present disclosure;

FIG. 13 illustrates an example signal structure for signals transmitted in a wireless communication system according to embodiments of the present disclosure;

FIG. 14 illustrates an example signal structure for signals transmitted in a wireless communication system according to embodiments of the present disclosure;

FIG. 15 illustrates an example signal structure for signals transmitted in a wireless communication system according to embodiments of the present disclosure;

FIG. 16 illustrates an example signal structure for signals transmitted in a wireless communication system according to embodiments of the present disclosure;

FIG. 17 illustrates an example signal transmission procedure in a wireless communication system according to embodiments of the present disclosure;

FIGS. 18A and 18B illustrate example signal transmission procedures in a wireless communication system according to embodiments of the present disclosure;

FIG. 19 illustrates an example signal transmission in a wireless communication system according to embodiments of the present disclosure;

FIG. 20 illustrates example signal transmissions in a wireless communication system according to embodiments of the present disclosure;

FIGS. 21A and 21B illustrate example signal transmissions in a wireless communication system according to embodiments of the present disclosure;

FIG. 22 illustrates example signal transmissions in a wireless communication system according to embodiments of the present disclosure; and

FIG. 23 illustrates an example method performed by a UE in a wireless communication system according to embodiments of the present disclosure.

### DETAILED DESCRIPTION

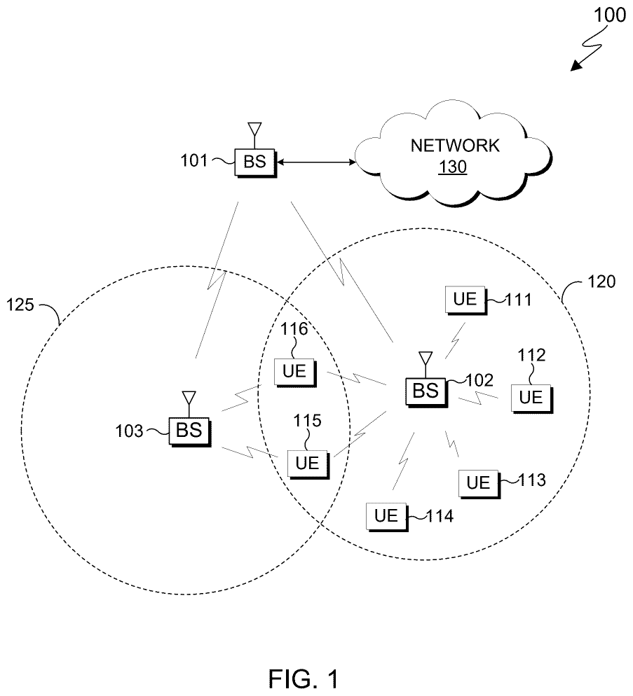

FIGS. 1-23 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, network and device energy saving and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band.

For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 38.211 v18.1.0, “NR; Physical channels and modulation;” [REF2] 3GPP TS 38.212 v18.1.0, “NR; Multiplexing and Channel coding;” [REF3] 3GPP TS 38.213 v18.1.0, “NR; Physical Layer Procedures for Control;” [REF4] 3GPP TS 38.214 v18.1.0, “NR; Physical Layer Procedures for Data;” [REF5] 3GPP TS 38.321 v18.0.0, “NR; Medium Access Control (MAC) protocol specification;” and [REF6] 3GPP TS 38.331 v18.0.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying resources allocations of signals for energy-efficient synchronization and beam acquisition. In certain embodiments, one or more of the gNBs 101-103 include circuitry, programing, or a combination thereof to enable resource allocation of signals for energy-efficient synchronization and beam acquisition.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

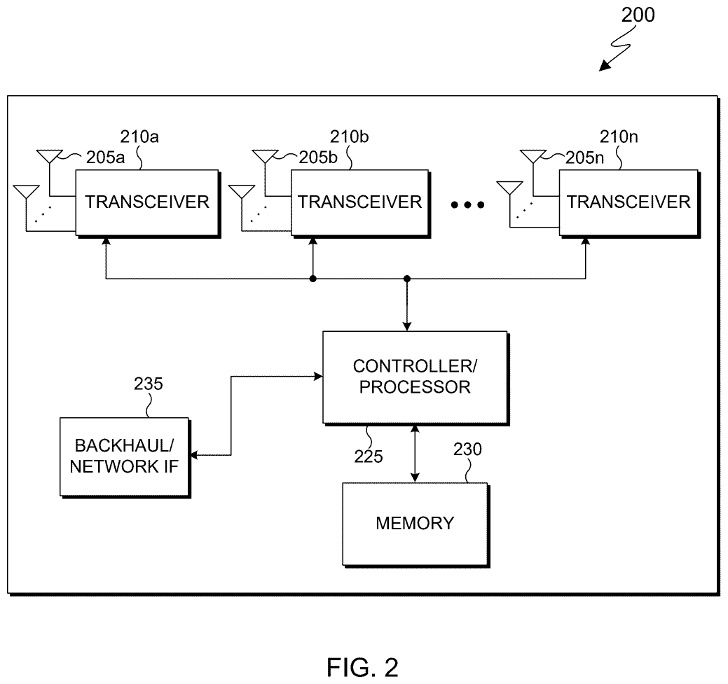

FIG. 2 illustrates an example BS 200 according to embodiments of the present disclosure. For example, the BS 200 any be a base station, such as gNB 101-103 in FIG. 1. The embodiment of the BS 200 illustrated in FIG. 2 is for illustration only. However, BSs come in a wide variety of configurations, and FIG. 2 does not limit the scope of this disclosure to any particular implementation of a BS.

As shown in FIG. 2, the BS 200 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs or gNBs in the network 100. In various embodiments, certain of the transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 200. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for enabling resource allocation of signals for energy-efficient synchronization and beam acquisition. Any of a wide variety of other functions could be supported in the BS 200 by the controller/processor 225.

The controller/processor 225 is also capable of executing programs and other processes resident in the memory 230, such as processes to enable resource allocation of signals for energy-efficient synchronization and beam acquisition. The controller/processor 225 can move data into or out of the memory 230 as required by an executing process.

The controller/processor 225 is also coupled to the backhaul or network interface 235. The backhaul or network interface 235 allows the BS 200 to communicate with other devices or systems over a backhaul connection or over a network. The interface 235 could support communications over any suitable wired or wireless connection(s). For example, when the BS 200 is implemented as part of a cellular communication system (such as one supporting 5G/NR, LTE, or LTE-A), the interface 235 could allow the BS 200 to communicate with other gNBs over a wired or wireless backhaul connection, for example, using a transceiver, such as described above with regard to transceivers 210. The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 200, various changes may be made to FIG. 2. For example, the BS 200 could include any number of each component shown in FIG. 2. Also, various components in FIG. 2 could be combined, further subdivided, or omitted and additional components could be added according to particular needs.

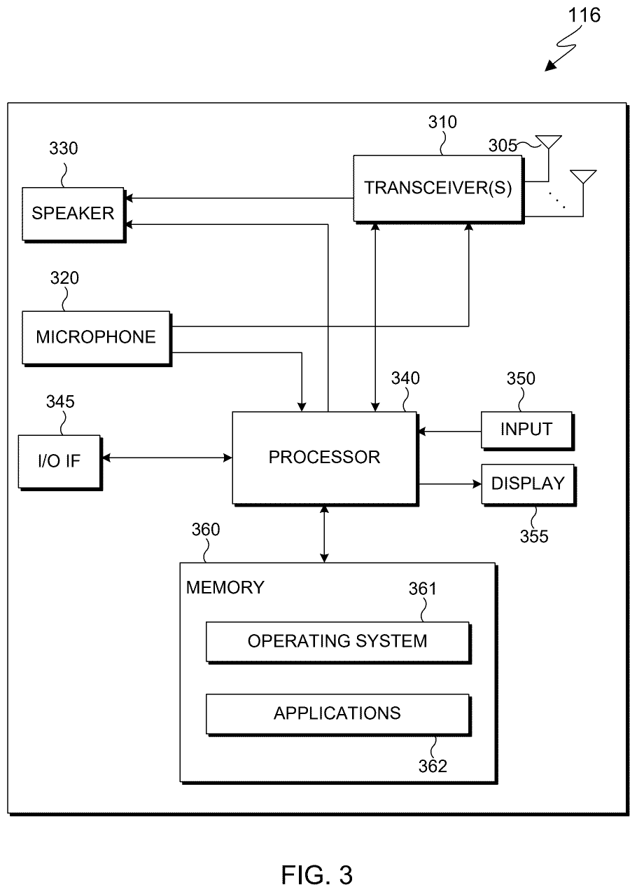

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for identifying resource allocations of signals for energy-efficient synchronization and beam acquisition as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

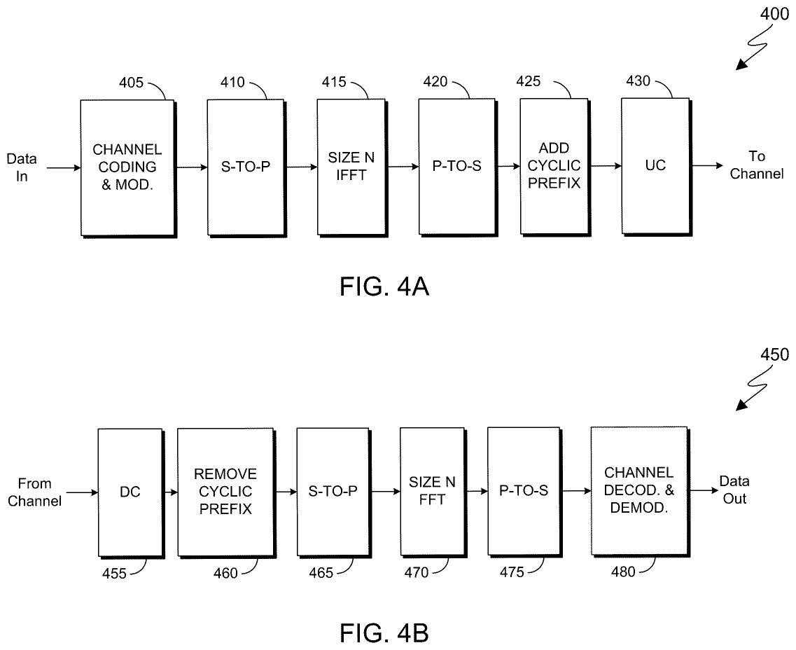

FIG. 4A and FIG. 4B illustrate an example of wireless transmit and receive paths 400 and 450, respectively, according to embodiments of the present disclosure. For example, a transmit path 400 may be described as being implemented in a gNB or TRP (such as gNB 102 or BS 200), while a receive path 450 may be described as being implemented in a UE (such as UE 116). However, it will be understood that the receive path 450 can be implemented in a gNB or TRP and that the transmit path 400 can be implemented in a UE. In some embodiments, the transmit path 400 and/or the receive path 450 is configured for enabling resource allocation of signals for energy-efficient synchronization and beam acquisition as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the gNBs 101-103 may implement a receive path 450 for receiving in the downlink from the gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In this disclosure, a beam can be determined by any of:
A TCI state, that establishes a quasi-colocation (QCL) relationship or spatial relation between a source reference signal (e.g. SSB and/or CSI-RS) and a target reference signal
A spatial relation information that establishes an association to a source reference signal, such as SSB or CSI-RS or SRS.

In either case, the ID of the source reference signal or TCI state or spatial relation information identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

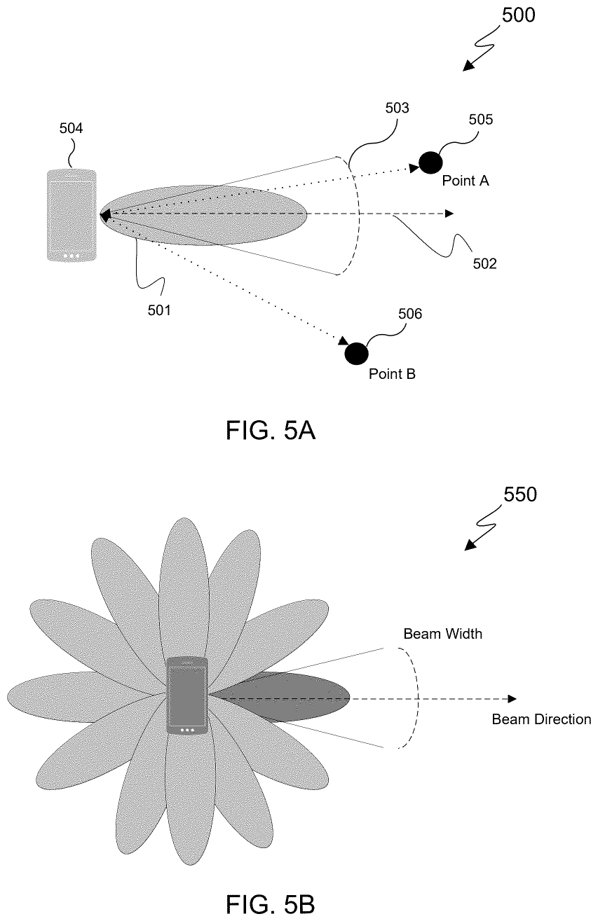

FIG. 5A illustrates an example beam operation 500 in a wireless communication system according to embodiments of the present disclosure. For example, beam operation 500 can be implemented by gNB 102 and/or any of the UEs 111-116 of FIG. 1. This example is for illustration only and other embodiments can be used without departing from the scope of the present disclosure.

As illustrated in FIG. 5A, in a wireless system, a beam (501), for a device (504), can be characterized by a beam direction (502) and a beam width (503). For example, a device (504) transmits radio frequency (RF) energy in a beam direction and within a beam width. A device (504) receives RF energy in a beam direction and within a beam width. As illustrated in FIG. 4A, a device at point A (505) can receive from and transmit to device (504) as Point A is within a beam width and direction of a beam from device (504). As illustrated in FIG. 5A, a device at point B (506) cannot receive from and transmit to device (504) as Point B is outside a beam width and direction of a beam from device (504). While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example multi-beam operation 550 in a wireless communication system according to embodiments of the present disclosure. For example, multi-beam operation 550 can be implemented by gNB 102 and/or any of the UEs 111-116 of FIG. 1. This example is for illustration only and other embodiments can be used without departing from the scope of the present disclosure.

As illustrated in FIG. 5B, in a wireless system, a device can transmit and/or receive on multiple beams. This is known as “multi-beam operation.” While FIG. 5B, for illustrative purposes, shows beams in 2D, it should be apparent to those skilled in the art, that beams can be 3D, where the beams can be transmitted to or received from any direction in space.

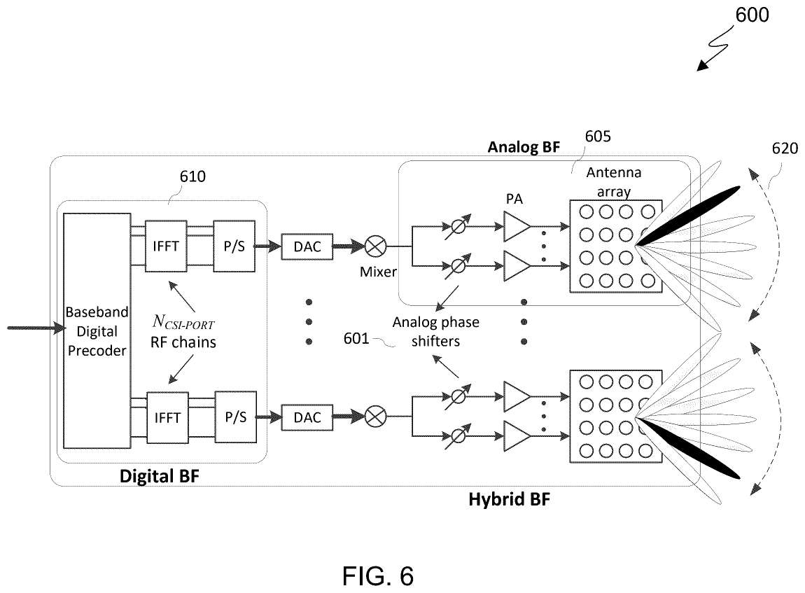

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH or dynamic-grant/configured-grant based PUSCH and all of dedicated PUCCH resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

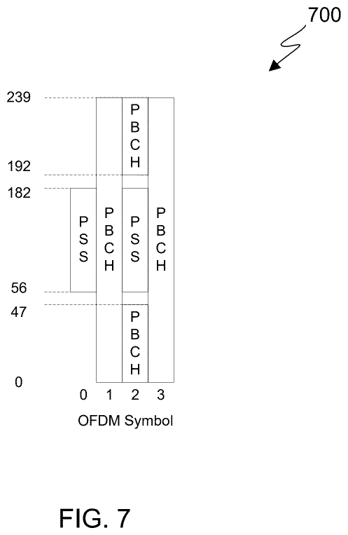

FIG. 7 illustrates an example of signals and a channel 700 for performing a cell search procedure according to embodiments of the present disclosure. For example, the signals and channel 700 can be transmitted by gNB 102 or received by any one of the UEs 111-116 of FIG. 1. This example is for illustration only and other embodiments can be used without departing from the scope of the present disclosure.

In 5G/NR, a UE performs the cell search procedure to acquire time and frequency synchronization with a cell and to detect the physical layer Cell ID of the cell. As illustrated in FIG. 7, to perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and consists of 4 consecutive symbols, and 20 physical blocks (240 subcarriers).

SSBs are organized in groups of N SSBs, transmitted within half a frame, each SSB within the group has an index i, where i=0, 1, . . . , N−1, within each group of SSBs, the SSBs are time-division multiplexed and arranged in increasing order of i, with increasing time. For carrier frequencies less than or equal to 3 GHZ, N=4. For carrier frequencies in FR1 that are larger than 3 GHz, N=8. For carrier frequencies in FR2, N=64. The SSB indices transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for connected mode mobility (e.g., handover), idle mode mobility (e.g., cell reselections), inter-RAT mobility to NR, and SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH consists of a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of RBs) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of TS 38.211.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {1/8, 1/4, 1/2, 1,2,4,8, 16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [38.213]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

A random access procedure can be initiated by a PDCCH order, by the MAC entity, or by RRC.

There are two types of random access procedures, type-1 random access procedure and type-2 random access procedure.

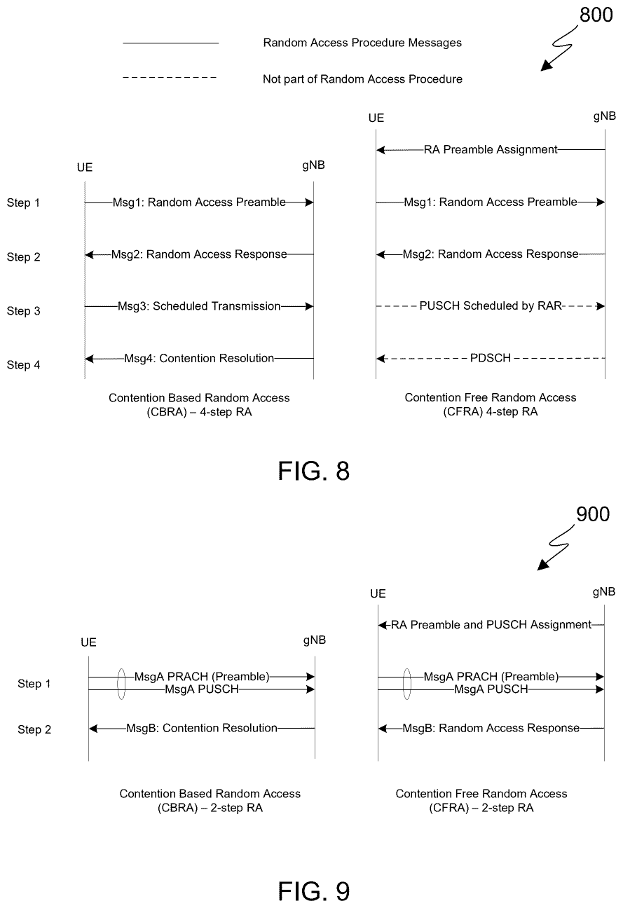

FIG. 8 illustrates a type-1 random access procedure 800 in a wireless communication system according to embodiments of the present disclosure. For example, type-1 random access procedure 800 can be implemented by gNB 102 and any one of the UEs 111-116 of FIG. 1. This example is for illustration only and other embodiments can be used without departing from the scope of the present disclosure.

Type-1 random access procedure, as is illustrated in FIG. 8, is also known as four-step random access procedure (4-step RACH);
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and an uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC reconfiguration complete message.
In step 4, the gNB upon receiving the RRC reconfiguration complete message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

FIG. 9 illustrates a type-2 random access procedure 900 in a wireless communication system according to embodiments of the present disclosure. For example, type-2 random access procedure 900 can be implemented by gNB 102 and any one of the UEs 111-116 of FIG. 1. This example is for illustration only and other embodiments can be used without departing from the scope of the present disclosure.

Rel-16 introduced this new type-2 random access procedure. Type-2 random access procedure, as is illustrated in FIG. 9, is also known as 2-step random access procedure (2-step RACH), and combines the preamble and PUSCH transmission into a single transmission from the UE to the gNB, which is known as MsgA. Similarly, the RAR and the PDSCH transmission (e.g. Msg4) are combined into a single downlink transmission from the gNB to the UE, which is known as MsgB.

A random access procedure can be triggered for initial access from the RRC IDLE state. During this procedure, a UE identifies an SS/PBCH block with index i and with an RSRP that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with CRC scrambled by a corresponding RA-RNTI during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a C-RNTI, the UE attempts to detect a DCI format 1_0 with CRC scrambled by a corresponding TC-RNTI scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

In this disclosure, initial beam acquisition in a higher-frequency carrier (e.g., FR2 or FR3) is provided. To assist with beam acquisition in higher-frequency carrier, signaling in a lower frequency carrier (e.g., FR1) can be used. For example, FR1 can be a frequency range that is less than 7.125 GHZ, FR3 can be a frequency range between 7.125 GHz and 24.25 GHZ, and FR2 can be a frequency range above 24.25 GHz to up to 100 GHz. In one example, a base station transmits synchronization signals and/or system information in the lower frequency carrier to provide information to the UE related to higher frequency carrier(s) and to assist with the beam acquisition in the higher frequency carriers. In one example, a UE transmits a signal to the network on a lower-frequency carrier to assist with beam acquisition in a higher frequency carrier.

As aforementioned, during initial access, a UE uses the random access procedure for initial beam acquisition, where the spatial domain filters (beams) identified during initial access, are used for subsequent transmissions and receptions to/from the UE until a single TCI state is configured or activated or indicated to the UE. To identify the beam, the UE preforms Rx beam sweeping to find a SS/PBCH block index with a RSRP that exceeds a threshold. This can be a time consuming procedure, for example, if the UE has M Rx beams, and the SS/PBCH periodicity is T ms, this would take up to MT ms to identify a beam from the network. In FR2, M can be large to provide a large beam gain which improves detection sensitivity, but that occurs at the expense of UE/network power consumption due to the requirement for more beam sweeping. There is a tradeoff between the time to identify a beam and T. The shorter T is, the shorter the latency for initial access, however, shorter T implies more overhead and more network energy consumption.

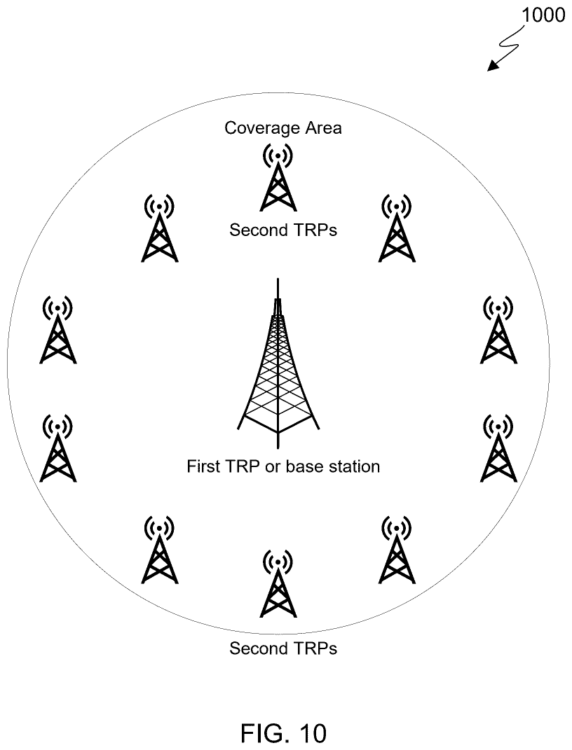

To address the aforementioned issues, FR1 can be used to assist with beam acquisition in FR2. In one embodiment, when a base station operates in multiple frequency bands, initial access is performed in a frequency band with a lower frequency, where wide beams or even a single beam (e.g., omni direction transmission or reception) can be used. A UE can send an uplink trigger signal or a wake up signal (WUS) to request and/or assist with beam acquisition in a higher frequency band where narrower beams can be used. Another embodiment is shown in FIG. 10, discussed below.

FIG. 10 illustrates an example base station or TRP operation 1000 in a wireless communication system according to embodiments of the present disclosure. For example, base station or TRP operation 1000 can include any one of gNBs 101-103. This example is for illustration only and other embodiments can be used without departing from the scope of the present disclosure.

In this embodiment, as illustrated in FIG. 10, a first base station or a first TRP operating in a lower frequency band covers a wide area that includes multiple second base stations or second TRPs that can operate in a higher frequency band. The second base stations or second TRPs can be non-collocated with the first base station or first TRP. The UE first communicates with the first base station on a lower frequency band that provides assistance for establishing a link with the second base stations on a higher frequency band.

In FIG. 10, a first TRP or base station can serve a large coverage area (e.g., for coverage). Second TRPs or base stations can serve smaller coverage areas (e.g., for capacity). In one example, the first TRP or base station is on. In one example, the second TRPs or base stations can be turned on or off based on traffic in corresponding cell or area of coverage. In one example, the first TRP or base station transmits a first reference signal as described in this disclosure. In one example, the first reference signal can be transmitted in a lower frequency band (e.g., FR1). In one example, the first reference signal uses omni-directional antennas. In one example, the second TRPs or base stations are turned off if there is no traffic in respective cells or coverage areas. In one example, the second TRPs or base stations can be activated or turned on by the first TRP or base station. In one example, the second TRPs or base stations can be activated or turned on by a signal (e.g., wake up signal (WUS), e.g., low power (LP) WUS) from a UE. In one example, the second TRPs when turned on can transmit reference signal for fine timing and/or power control and/or spatial relation. In one example, the second TRPs when turned on can receive signals or channels in UL. In one example, if a UE transmits a WUS or LP WUS, the timing can be based on timing acquired from first TRP or base station. In one example, if a UE transmits a WUS or LP WUS, the timing can be based on timing acquired from GPS. In one example, the timing of the WUS or LP WUS from the UE is pre-configured. In one example, the timing of the WUS or LP WUS from the UE is configured from first base station or TRP. In one example, the timing of the WUS or LP WUS from the UE is configured from a second base station or TRP. In one example, WUS or LP WUS can include positioning information of UE.

In this disclosure, signaling and network/UE procedure aspects related to lower frequency band-assisted beam acquisition for a higher frequency band are provided, or in general signaling transmitted in a frequency band (or cell) to assist with beam acquisition in another frequency band or another cell.

The present disclosure relates to a 5G/NR and/or 6G communication system. More specifically, the present disclosure relates to a method and apparatus for resource allocation of signals for energy-efficient synchronization and beam acquisition.

This disclosure provides aspects related to design of FR1 assisted beam acquisition in FR2:
Network-provided assistance information in a lower frequency band for beam acquisition in a higher frequency band.
Signaling from a UE in a lower frequency band to assist with beam acquisition in a higher frequency band.
Timing aspects for beam acquisition in a higher frequency band.

Aspects, features, and advantages of the present disclosure are readily apparent from the following detailed description, simply by illustrating a number of particular embodiments and implementations, including the best mode contemplated for carrying out the present disclosure. The present disclosure is also capable of other and different embodiments, and its several details can be modified in various obvious respects, all without departing from the spirit and scope of the present disclosure. Accordingly, the drawings and description are to be regarded as illustrative in nature, and not as restrictive. The present disclosure is illustrated by way of example, and not by way of limitation, in the figures of the accompanying drawings.

In the following, both FDD and TDD are considered as a duplex method for DL and UL signaling. In addition, full duplex (XDD) operation is possible, e.g., sub-band full duplex (SBFD) or single frequency full duplex (SFFD).

Although exemplary descriptions and embodiments to follow assume orthogonal frequency division multiplexing (OFDM) or orthogonal frequency division multiple access (OFDMA), this present disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE, where the information can be common/cell-specific information or dedicated/UE-specific information, or (3) UE-group RRC signaling.

In this disclosure MAC CE signaling can be UE-specific e.g., to one UE or can be UE common (e.g., to a group of UEs or all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE or can be UE common (e.g., to a group of UEs or all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N-1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

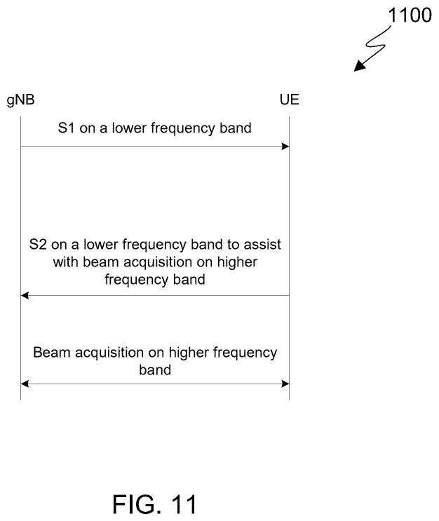

FIG. 11 illustrates an example signal transmission procedure 1100 in a wireless communication system according to embodiments of the present disclosure. For example, procedure 1100 can be implemented by gNB 102 and any of the UEs 111-116 of FIG. 1. This example is for illustration only and other embodiments can be used without departing from the scope of the present disclosure.

In a first embodiment, as illustrated in FIG. 11, a base station transmits a first signal(s) or channel(s), denoted as S1, in a lower carrier frequency band (e.g., in FR1). A UE receives S1 and in response transmits a second signal(s) or channel(s), denoted as S2, based on S1. For example, S2 is a trigger or request or WUS from the UE for acquisition of a cell on a higher frequency band (e.g., in FR2). Based on information carried in S1 and/or S2 assistance is provided for beam acquisition on a higher carrier frequency band (e.g., in FR2).

In one example, S1 can consist of one or more of the following:
Signal(s) or channel(s) for the UE to establish time and/or frequency synchronization. For example, these can be signals such as or similar to the primary synchronization signal (PSS) and the secondary synchronization signal (SSS). In one example, these signal(s), or channel(s) can be Low-Power Synchronization Signals (LP-SS). In one example, the LP-SS are received on a radio separate from the main radio (e.g., low-power radio). In one example, these signal(s), or channel(s) can be channel state information reference signals (CSI-RS).
Signals or channel(s) to provide a physical cell identity.
Signal(s) or channel(s) to provide system information. For example, these can be channels such as or similar to the PBCH, which provides a master information block (MIB), and physical downlink shared channel (PDSCH), which provides a system information block (SIB), e.g., SIB1.

In one example, the S1 signal or channel has an associated index, e.g., referred to as S1 index. S1 signals with different indices can be associated with different spatial domain transmission filters. In one example, the S1 index can be determined by PSS and/or SSS and/or PBCH DM-RS and/or PBCH associated with S1 (e.g., SS/PBCH block index or SS index).

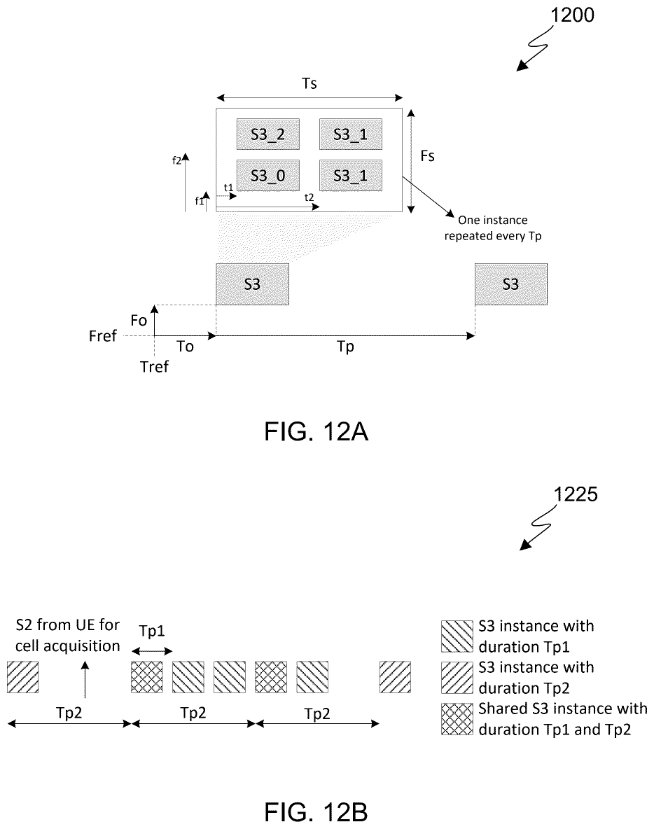

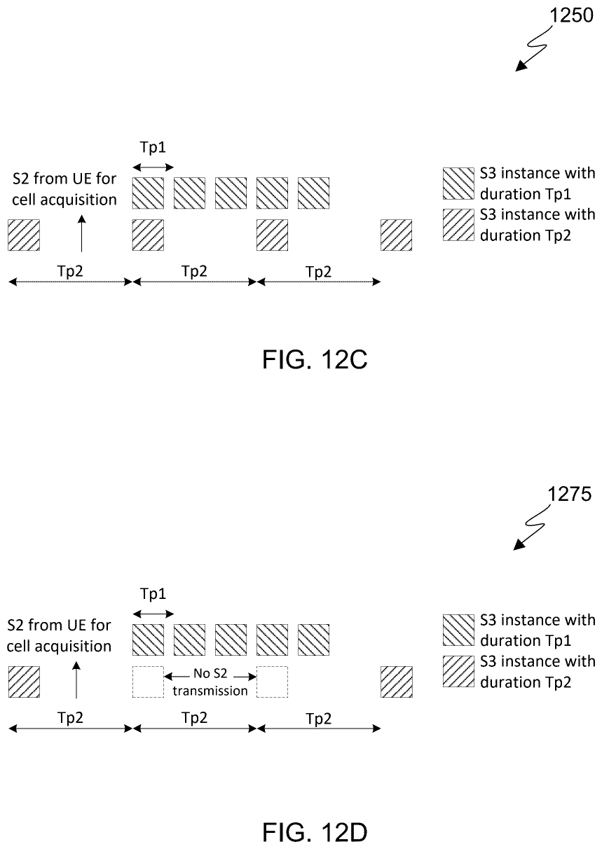

FIGS. 12A-12D illustrate example signal structures 1200, 1225, 1250, and 1275, respectively, for a signal transmitted in a wireless communication system according to embodiments of the present disclosure. For example, signal structure 1200, 1225, 1250, or 1275 can be implemented by gNB 102 of FIG. 1. These examples are for illustration only and other embodiments can be used without departing from the scope of the present disclosure.

In one example, the system information includes information to assist with initial beam acquisition on a higher frequency band. The system information can include one or more of the following:
Available carriers or frequency bands e.g., in FR2 or FR3.
Signal, S3, (e.g., for synchronization and/or beam acquisition) structure or timing in a frequency band or a carrier. For example, as illustrated in FIG. 12A this can include one or more of the following (in the context of the following, a signal group is a group of signal indices transmitted periodically, the group of signals (also referred to as a group of indices) is transmitted in each instance of the periodic transmission or as an aperiodic transmission):
   Available signal indices within a signal group. For example, this can include the transmitted S3 indices (e.g., synchronization signal indices or reference signal indices) within a signal group. In one example, S3 indices are transmitted with the same power, in one example, that power level is indicated. In one example, S3 indices are transmitted with different power levels and the power level is indicated for each S3 index, or the relative power level (e.g., in dB) to the S3 index with the largest or smallest power level is indicated, and the power level of the S3 index with the largest or smallest power is indicated. In one example, the power level of a first S3 index is indicated, and the relative power to the first S3 index is indicated for the other S3 indices, wherein the first S3 index is indicated or defined in the system specifications. In one example, if an S3 index is not transmitted, its power can be indicated as 0, or as minus infinity dBm (e.g., a codepoint is used to signal minus infinity dBm, or an absent value can be interpreted as minus infinity dBm).
   The time offset (To) of a signal group from a reference time (Tref). In one example, the reference time (Tref) can be determined by S1, as described later in this disclosure. In one example, the reference time (Tref), can be determined by S2 as described later in this disclosure. In one example, To-0. In one example, To depends on the sub-carrier spacing of S1 and/or S2 and/or S3. In one example, To is in units of symbols and/or slots and/or subframes and/or frames and/or time units. In one example, To is defined in the system specifications.
   The extent of each S3 occasion (Ts) in time domain. For example, this can correspond to the time window during which signals with different S3 indices can be transmitted.
      The periodicity (Tp) between two repetitions of S3. In one example, Tp can be same as the corresponding periodicity for S1. In one example, Tp can be related to corresponding periodicity for S1, for example, Tp is half or double the periodicity of S1. In one example, Tp can be such that consecutive instances of S1 are transmitted back-to-back, for example, to minimize beam sweeping time. In one example, there are two values of Tp. A first value, e.g., Tp1, with a short period, to assist with initial beam acquisition, and a second value, e.g., Tp2, with a longer period which can be used for, e.g., beam maintenance after initial beam acquisition. In one example, S3 can be transmitted with both periods as illustrated in FIG. 12B. In FIG. 12B, as an example, some S3 instances are associated with the period Tp1, and some S3 instances are associated with the period Tp2 and some S3 instances are shared for periods Tp1 and Tp2. In a variant of the example of FIG. 12B, there are no S3 instances shared for periods Tp1 and Tp2. In one example, the signal S3 used with period Tp1 and signal S3 used with period Tp2 can be of the same type, e.g., both can be SS blocks or CSI-RS blocks. In another example, S3 transmitted with period Tp1 can be of a first type and S3 transmitted with a period Tp2 can be of a second type, e.g., S3 associated with Tp1 can be CSI-RS and S3 associated with Tp2 can be SS blocks, or vice versa, S3 associated with Tp1 can be SS Blocks and S3 associated with Tp2 can be CSI-RS, in a variant example, signal S3 associated with period Tp1 and signal S3 associated with period Tp2 can be of the same type, but have distinguishable signals or sequences. In one example, as illustrated in FIG. 12C, S3 can be transmitted with both periods, and S3 with Tp1 and S3 with Tp2 use different signal types or distinguishable signals of the same type. In one example, as illustrated in FIG. 12D, S3 can be transmitted with period Tp1 or period Tp2. For example, when S3 is transmitted with period Tp1, the instances of period Tp2 can be skipped. In one example, the period Tp1 can be such that the S3 instances with period Tp1 are back-to-back, one instance starts at the end of (or right after) the previous instance, or after a short gap from the previous instance. In one example, the number of S3 instances with period Tp1 is N. In one example, the time duration during which S3 instances with period Tp1 are transmitted is T. In one example, N and/or T can be signaled in the information associated with S1. In one example, N and/or T can be requested or indicated by the UE, e.g., via S2. In example, N and/or T depend on the sub-carrier spacing of S3. In one example, N and/or T are defined in the system specifications. In one example, N=1. In one example, S3 with period Tp1 is transmitted until the UE requesting acquisition on the cell of S3 has acquired a beam or performed initial access of the cell of S3. In one example, after the signal S2 from the UE (e.g., based on To and Tref as aforementioned) the network sends S3 with period Tp1 for a certain number of instances, N, or a certain time duration, T and then reverts to sending S3 with period Tp2.
      The frequency offset (Fo) of a signal group from a reference frequency (Fref). In one example, Fref can be determined by the carrier frequency of S3. In one example, Fref can be determined by the carrier frequency of S2. In one example, Fref can be determined by the carrier frequency of S1. In one example, Fo=0. In example, Fo is in units of sub-carriers and/or RBs and/or sub-channels (where a sub-channel is a number of RBs) and/or frequency units. In one example, Fo is defined in the system specifications.
   The extent of each S3 occasion (Fs) in frequency domain. For example, this can correspond to the frequency window in which signals with different S3 indices can be transmitted.
   Time domain/frequency domain structure of signal indices within a group, including t1, t2, . . . , and f1, f2, . . . . In some examples, some of this information can be defined in the system specification.
   Number, N, of repetitions of S3, or the time duration, T, during which S3 is transmitted. In one example, N and/or T can be signaled in the information associated with S1. In one example, N and/or T can be requested and/or indicated by the UE, e.g., via S2. In example, N and/or T depend on the sub-carrier spacing of S3. In one example, N and/or T are defined in the system specifications. In one example, S3 is repeated unit the occurrence of the next instance of S1. In one example, S3 is transmitted until the UE requesting acquisition on the cell of S3 has acquired a beam or performed initial access of the cell of S3. In one example, the number N and/or T can depend on the number of Rx beams the UE sweeps.
   In one example, a UE may assume a same spatial domain transmission filter for S3 signals with a same index transmitted in different instances. This is referred to as S3 index.
   Information related to beam acquisition in FR2 or FR3, for example information related to the signal a UE transmits as part of the initial access or beam acquisition on the cell or carrier of signal S3, e.g., PRACH preamble/PRACH occasion or on-off-keying (OOK) signal association with the S3 signal index.
An indication of whether signal S3 is transmitted or not.
Information related to signal S2 transmission in FR1 or FR2 or FR3, for example information related to transmission occasions and/or resources for signal S2, e.g., PRACH preamble/PRACH occasion, or on-off-keying (OOK) signal or WUS or LP WUS association with the S1 signal index or the S3 signal index.

In one example, S3 can consist of one or more of the following:
Signal(s) or channel(s) for the UE to establish time and/or frequency synchronization and identify one or more beams for communication between the UE and the network. For example, these can be signals such as or similar to the primary synchronization signal (PSS) and the secondary synchronization signal (SSS).
Signals or channel(s) to provide a physical cell identity.
Signal(s) or channel(s) to provide system information. For example, these can be channels such as or similar to the PBCH, which provides a master information block (MIB), and physical downlink shared channel (PDSCH), which provides a system information block (SIB), e.g., SIB1.
Signals to identify one or more beams for communication between the UE and the network. For example, these can be reference signals such as channel state information-reference signals (CSI-RS), wherein the CSI-RS can be for tracking purposes (e.g., time and/or frequency tracking) hence referred to as tracking reference signal (TRS), or the CSI-RS can be for beam management purposes, hence referred to as beam management CSI-RS, or the CSI-RS can be for channel state information acquisition purposes, hence referred to as channel state information CSI-RS.

In one example, the system information for carrier frequency 2 (e.g., FR2 or FR3) in which S3 is transmitted is provided with S3 or associated with S3. In one example, the system information for carrier frequency 2 (e.g., FR2 or FR3) in which S3 is transmitted is provided with S1 or associated with S1. In one example, the system information for carrier frequency 2 (e.g., FR2 or FR3) in which S3 is transmitted is provided with S1 or S3 or associated with S1 or S3. In one example, a UE acquires the system information for carrier frequency 2 (e.g., FR2 or FR3) in which S3 is transmitted based on a signal associated with S1 until the UE has performed initial access or performed beam acquisition on the carrier associated with S3 (e.g., carrier frequency 2). After the UE has performed initial access or has acquired a beam on the carrier associated with S3 (e.g., carrier frequency 2) the UE acquires system information for carrier frequency 2 (e.g., FR2 or FR3) in which S3 is transmitted based on a signal associated with S3. In one example, a first part of the system information of carrier frequency 2 (e.g., FR2 or FR3) in which S3 is transmitted is provided with S1 or associated with S1, and a second part of the system information of carrier frequency 2 (e.g., FR2 or FR3) in which S3 is transmitted is provided with S3 or associated with S3. In one example, the system information can include information associated an S3 index with an UL transmission resource/occasion (e.g., PRACH preamble index and/or PRACH preamble occasion or OOK signal or WUS or LP WUS), wherein the UL transmission is on carrier frequency 2 (e.g., FR2 or FR3).

In one example, S3 includes signal(s) or channel(s) for the UE to establish time and/or frequency synchronization and identify one or more beams for communication between the UE and the network. For example, these can be signals such as or similar to the primary synchronization signal (PSS) and the secondary synchronization signal (SSS). In one example, this can be referred to as a low power (LP) signal, e.g., LP-SS. In one example, S3 includes signals to identify one or more beams for communication between the UE and the network. For example, these can be reference signals such as channel state information-reference signals (CSI-RS).

In one example, the S3 index can be determined by PSS and/or SSS associated with S3. In one example, the S3 index can be determined by CSI-RS (e.g., CSI-RS ID) associated with S3

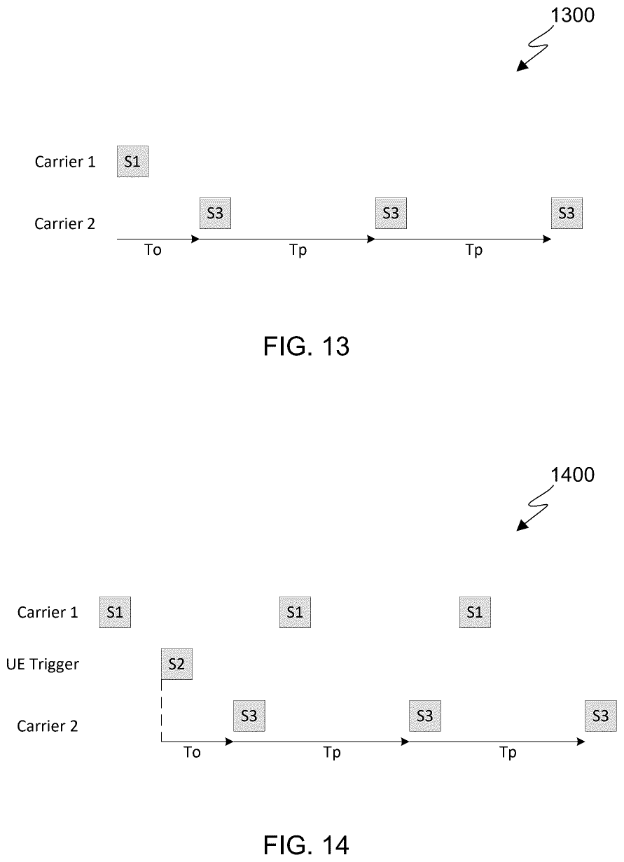

FIG. 13 illustrates an example signal structure 1300 for signals transmitted in a wireless communication system according to embodiments of the present disclosure. For example, signal structure 1300 can be implemented by gNB 102 of FIG. 1. This example is for illustration only and other embodiments can be used without departing from the scope of the present disclosure.

In one example, S3 can be transmitted from a gNB without triggering or request from a UE. In one example, S3 is triggered by another UE. In one example, S3 is transmitted by the gNB without triggering or request from a UE. In one example, a gNB can transmit S1 and S3 as illustrated in FIG. 13. In one example, S3 is transmitted with a signal structure and an offset To and/or a periodicity Tp and/or with N transmission occasions and/or a number of indices as aforementioned and illustrated in FIG. 12A and FIG. 12B and FIG. 12C and FIG. 12D. The assistance information included in S1, provides the UE information about S3 transmission instances and S3 transmission indices, as aforementioned, e.g., the parameters related to S3 structured and To and/or Tp and/or N and/or frequency domain parameters are included in S1. This can assist the UE in doing beam sweeping across the S3 transmission instances and S3 transmission indices.

FIGS. 14, 15, and 16 illustrate example signal structures 1400, 1500, and 1600, respectively, for signals transmitted in a wireless communication system according to embodiments of the present disclosure. For example, signal structures 1400, 1500, and 1600 can each be implemented by gNB 102 and any one of the UEs 111-116 of FIG. 1. These examples are for illustration only and other embodiments can be used without departing from the scope of the present disclosure.

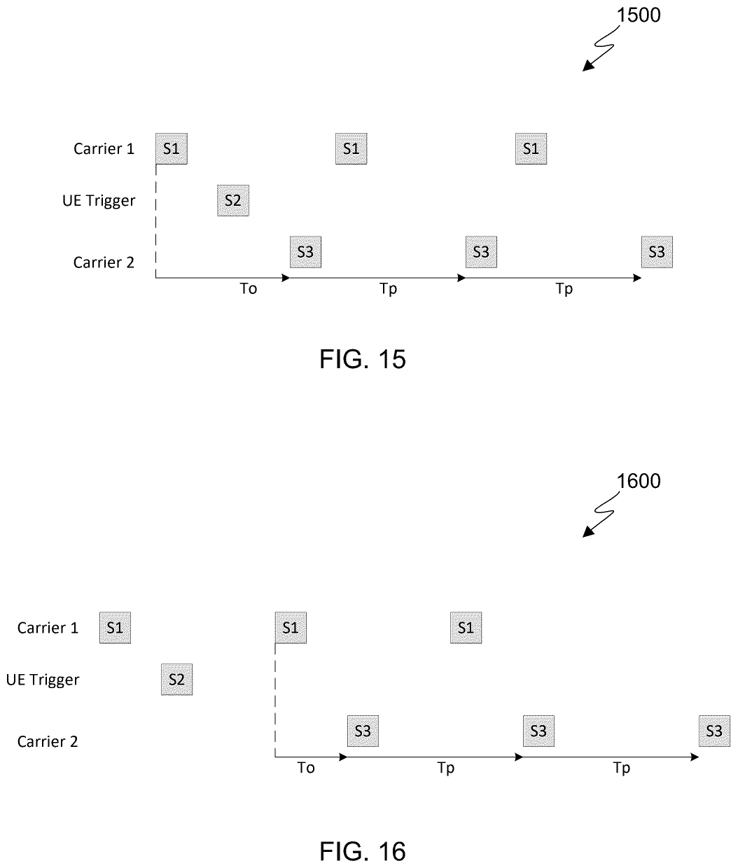

In one example, S3 is transmitted in response to a trigger or a request or WUS or LP WUS from a UE (e.g., in response to signal S2). In one example, S3 is transmitted with a signal structure and an offset To and/or a periodicity Tp and/or with N transmission occasions as aforementioned and illustrated in FIG. 12A. In one example, the parameters related to S3 structured and To and/or Tp and/or N and/or S3 indices are included in S1 as aforementioned. In one example, To is relative to S2 as illustrated FIG. 14. In one example, To is relative to S1, for example, the S1 instance associated with the trigger or request signal (S2) from the UE as illustrated in FIG. 15, or in another example, the S1 instance after the trigger or request signal from the UE as illustrated in FIG. 16. In FIG. 15, S3 is To after a corresponding S1 instance, and the first S3 instance occurs after S2 (e.g., subject to a processing latency). In FIG. 16, S3 is To after a corresponding S1 instance, and the first S3 instance occurs after the first S1 instance that occurs after S2 (e.g., subject to a processing latency).

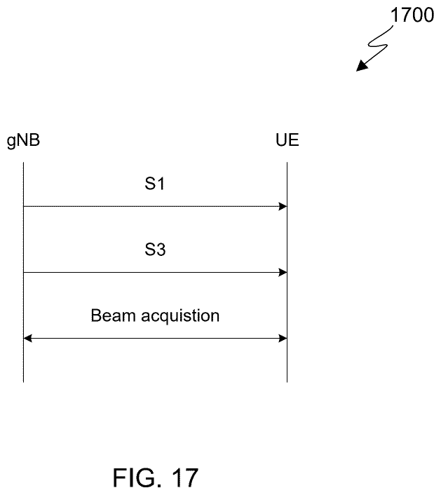

FIG. 17 illustrates an example signal transmission procedure 1700 in a wireless communication system according to embodiments of the present disclosure. For example, procedure 1700 can be implemented by gNB 102 and any of the UEs 111-116 of FIG. 1. This example is for illustration only and other embodiments can be used without departing from the scope of the present disclosure.

In one example, as illustrated in FIG. 17,
A gNB transmits S1 on carrier frequency 1. S1 can include information related to S3.
UE can receive S1 to acquire information about S3.
The gNB transmits signal S3 on carrier frequency 2.
The UE uses signal S3 for beam acquisition on carrier frequency 2.

In one example, the gNB transmits S1 on carrier frequency 1. In one further example, this signal can include a first information about other available carriers or frequency bands and about S3 timing and/or structure and/or frequency information.

In one example, the UE receives S1 on carrier frequency 1, uses this signal for time and/or frequency synchronization and/or to acquire the physical cell identity. In one example, the UE acquires first information about S3 timing and/or structure and/or frequency information.

In one example, the UE can transmit a signal S0 to trigger transmission of S1. In one example, S0 is on carrier frequency 1.

In one example, the gNB transmits signal, S3, (e.g., for synchronization and/or beam acquisition) on carrier frequency 2, this signal can be transmitted based on the first information.

In one example, the UE uses signal S3 for beam acquisition on carrier frequency 2. The network identifies an S3 index. In one example, the identified S3 index corresponds to an S3 signal with RSRP or SINR exceeding a threshold. In one example, the identified S3 index corresponds to an S3 signal with the largest RSRP or SINR. The UE transmits an UL signal or channel (e.g., PRACH or WUS or LP-WUS) corresponding to the S3 index, based on the system information provided by the network as aforementioned. The spatial domain filter associated with the identified S3 signal is used for subsequent transmissions from the network to UE (e.g., DL transmissions) on carrier frequency 2. The spatial domain filter associated with the UL signal or channel is used for subsequent transmissions from the UE to the network (e.g., UL transmissions) on carrier frequency 2. The spatial domain filters are used until a new spatial domain filter or beam, or TCI state or spatial relation is configured or activated or indicated to the UE for DL and UL transmissions respectively.

In one example, the first information provided in S1, includes timing information for S3, such as Ts, To, and Tp of FIG. 12A. For example, the first information provides a synchronization signal measurement time configuration window or reference signal measurement time configuration window for S3, during which the UE can search or attempt to receive S3.

In one example, the first information provided in S1, includes signal structure and timing information for S3 as illustrated in FIG. 12A. For example, this can include the synchronization signal (or reference signal) instances or indices being transmitted and their timing and/or frequency information or can include the synchronization signal (or reference signal) instances or indices not being transmitted. It is also possible that a bit indicates whether the first information is for transmitted or non-transmitted synchronization signal (or reference signal) instances or indices and then a NW can choose the information resulting to less signaling overhead (fewer number of bits).

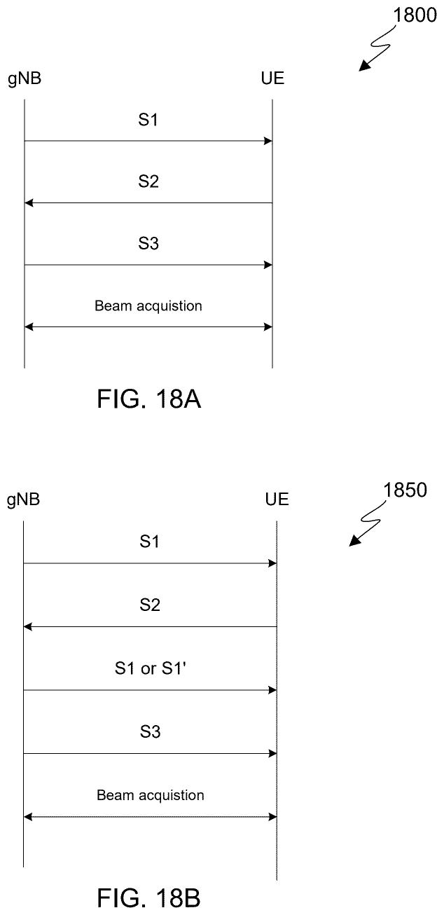

FIG. 18A and FIG. 18B illustrate example signal transmission procedures 1800 and 1850, respectively, in a wireless communication system according to embodiments of the present disclosure. For example, procedures 1800 and 1850 can each be implemented by gNB 102 and any of the UEs 111-116 of FIG. 1. These examples are for illustration only and other embodiments can be used without departing from the scope of the present disclosure.

In one example, as illustrated in FIG. 18A and FIG. 18B,
A gNB transmits S1 on carrier frequency 1.
A UE receives S1 on carrier frequency 1, uses this signal for time and/or frequency synchronization and/or to acquire the physical cell identity, and possibly to acquire occasions and/or resource for transmission of S2.
A UE transmits a trigger or a request (signal S2) to the network for transmission on a carrier frequency 2. In one example, S2 is transmitted on carrier frequency 1. In one example, S2 is transmitted on carrier frequency 2.
The gNB receives the signal S2.
The gNB in response to signal S2, transmits signal S3 on carrier frequency 2. In one example as illustrated in FIG. 18B, gNB can update the information provided by the S1 signal or transmit another signal (e.g., a second S1, S1′) to include information about S3 (e.g., when S2 is transmitted on carrier frequency 1). In one example, gNB can send a UE dedicated signal that includes information about S3. In one example, gNB can send a UE common (for all UEs in a cell or for a group of UEs) that includes information about S3. In one example, the UE receives the information about signal S3 (e.g., signal S1 or S1′ of FIG. 18B).
The UE uses signal S3 for beam acquisition on carrier frequency 2.

In one example, the gNB transmits S1 on carrier frequency 1. In one further example, this signal can include a first information about other available carriers or frequency bands.

In one example, the UE receives S1 on carrier frequency 1, uses this signal for time and/or frequency synchronization and/or for initial beam acquisition and/or to acquire the physical cell identity. In one example, the network provides information about the timing and structure of signal S2 transmitted from the UE. In one example, the network indicates a spatial filter(s) for the signal S2 transmission. In one example, the network indicates the transmission occasion(s) and transmission resource(s) for the signal S2. In example, the network indicates the association of a spatial filter(s) (e.g., based on S1 index(es) or based on S3 index(es)) with transmission occasion(s) and resource(s) for the signal S2. In one example, the network indicates a path-loss adjustment factor, e.g., that can be indicated in information provided in S1. In one example, the signal S2 is transmitted on carrier frequency 1 or a frequency in FR1 or a carrier frequency of the signal S1. In one example, the signal S2 is transmitted on carrier frequency 2 or a frequency in FR2 or FR3 or a carrier frequency of the signal S3.

In one example, the UE transmits a trigger or a request or a WUS (signal S2) to the network for transmission on a carrier frequency 2. In one further example, carrier frequency 2 is included in the first information from the gNB.

In one example, the gNB in response to the trigger or request from the UE transmits Signal, S3, (e.g., for synchronization and/or initial beam acquisition) on carrier frequency 2.

In one example, the gNB in response to the trigger or request from the UE updates the signal S1 with information about S3 (if not already included), or transmits a second signal S1′ with information up S3. Wherein the transmission can be using UE common (e.g., cell-specific) signaling, or UE-dedicated (e.g., UE-specific) signaling.

In one example, the UE uses signal S3 for beam acquisition on carrier frequency 2. The network identifies an S3 index. In one example, the identified S3 index corresponds to an S3 signal with RSRP or SINR exceeding a threshold. In one example, the identified S3 index corresponds to an S3 signal with the largest RSRP or SINR. The UE transmits an UL signal or channel (e.g., PRACH or WUS or LP-WUS) corresponding to the S3 index, based on the system information provided by the network as aforementioned. The spatial domain filter associated with the identified S3 signal is used for subsequent transmissions from the network to UE (e.g., DL transmissions) on carrier frequency 2. The spatial domain filter associated with the UL signal or channel is used for subsequent transmissions from the UE to the network (e.g., UL transmissions) on carrier frequency 2. The spatial domain filters are used until a new spatial domain filter or beam, or TCI state or spatial relation is configured or activated or indicated to the UE for DL and UL transmissions respectively.

In one example, the first information provided in S1 or S1′, includes timing information for S3, such as Ts, To, and Tp of FIG. 12 and FIG. 12B and FIG. 12C and FIG. 12D. For example, the first information provides a synchronization signal measurement time configuration window or reference signal measurement time configuration window for S3, during which the UE can search or attempt to receive S3. For example, the first information also provides a PRACH resource configuration or WUS or LP-WUS resource configuration or, in general, a configuration for transmission of a channel or signal on carrier frequency 2. In one example, the configuration is for the signal S2. In one example, the configuration is for a transmission from the UE after receiving S3, e.g., as part of the initial access or beam acquisition on carrier frequency 2 or a frequency in FR2 or a carrier frequency of the signal S3.

In one example, the first information provided in S1, includes signal structure and timing information and frequency information for S3 as illustrated in FIG. 12A, FIG. 12B, FIG. 12C, and FIG. 12D. For example, this can include the synchronization signal or reference signal (e.g., CSI-RS) instances being transmitted and their timing and/or frequency information.

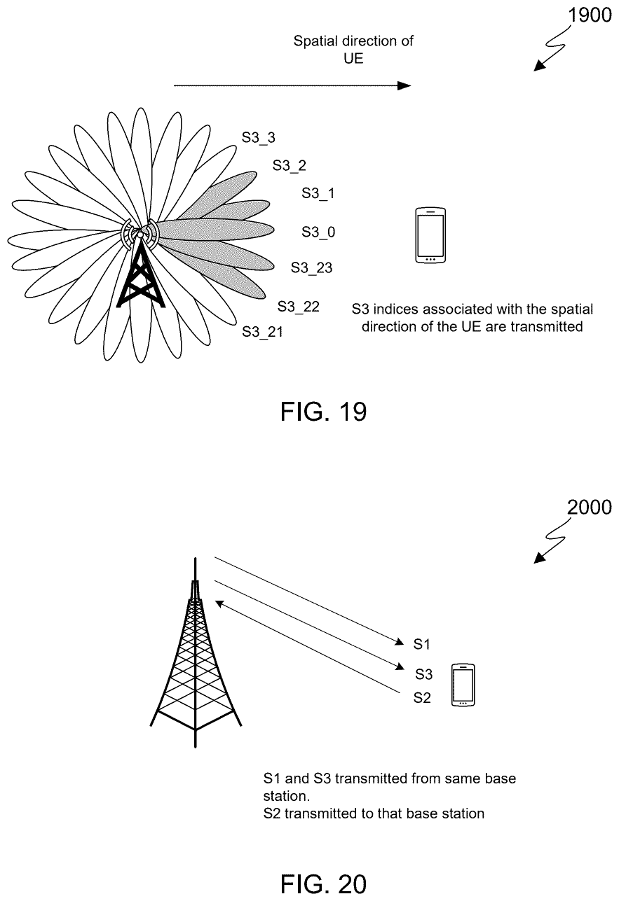

FIG. 19 illustrates an example signal transmission 1900 in a wireless communication system according to embodiments of the present disclosure. For example, signal transmission 1900 can be implemented by gNB 102 of FIG. 1. This example is for illustration only and other embodiments can be used without departing from the scope of the present disclosure.

As illustrated in FIG. 19, in one example, the network (e.g., gNB) can determine a spatial direction for the UE and transmit S3 signal indices corresponding to the spatial filters associated with the spatial direction. In FIG. 19, the network (e.g., eNB) can determine the spatial direction of a UE, and determine the S3 (e.g., synchronization signal or reference signal (e.g., CSI-RS) on carrier frequency 2 or a frequency in FR2 or FR3 or a carrier frequency of the signal S3) indices that are associated with the spatial direction and transmit these. In the example, of FIG. 19, these are S3_0, S3_1, S3_2, S3_22 and S3_23. In one example, the transmitted S3 indices can be included in the associated S1 or S1′ information.

In one example, based on S2 network (e.g., gNB) can determine the spatial direction of UE and transmit S3 signal indices corresponding to the spatial direction.
In one example, the UE provides information in S2 signal to assist the network in determining the spatial direction of the UE. In one example, the assistance information can include UE positioning information. In one example, the positioning information can be RAT dependent information, e.g., based on RAT dependent positioning measurements. In one example, the positioning information can be RAT independent positioning information, e.g. based on global positioning system (GPS) location or inertial measurement unit (IMU) measurements. Wherein, the IMU can consist of sensors such as accelerometer, gyroscope, and magnetometer. In one example, the assistance information can be RSRP or SINR measurement of S1. In one example, the assistance information can be RSRP or SINR measurement of S1 and the associated S1 index. In one example, the assistance information can be RSRP or SINR measurement of S1 from the cell from which S2 is determined or transmitted to. In one example, the assistance information can be RSRP or SINR measurement of multiple S1 indices from the cell from which S2 is determined or transmitted to. In one example, the assistance information can be RSRP or SINR measurement of S1 from neighboring cells.
In one example, the network can determine based on its implementation the direction of arrival of the signal S2 and hence the spatial direction of the UE.
In one example, the UEs have a known location (e.g., for stationary UEs such a meter readers). In one example, the positioning information is configured in the UE and it provided by the UE to network. In one example, the UE provides a UE ID and the location of the UE is configured in the network and determined based on the UE ID.

In one example, the signal S2 consist of a single UL transmission from the UE. In one example, the signal S2 consists of a single UL transmission from the UE that includes one part/stage. In one example, the signal S2 consists of a single UL transmission from the UE that includes a first part/stage and a second part/stage. In one example, the signal S2 consists of a single UL transmission from the UE that includes a first part/stage and a second part/stage, and the first part/stage includes information about the second part/stage (e.g., payload size and/or modulation coding scheme and/or resources). In one example, the signal S2 consists of a single UL transmission from the UE that includes N part(s)/stage(s). In one example, the signal S2 consists of a single UL transmission from the UE that includes N part(s)/stage(s), and part/stage i includes information about part/stage j, where j>i.

In one example, the signal S2 consist of multiple (e.g., N, where N>1) UL transmissions from the UE. In one example, N=2. In one example, a first UL transmission includes a first part/stage, and a second UL transmission includes a second part/stage, and a third UL transmission includes a third part/stage, . . . . In one example, a first UL transmission includes a first part/stage, and a second UL transmission includes a second part/stage, and the first part/stage includes information about the second part/stage (e.g., presence of second part/stage and/or payload size and/or modulation coding scheme and/or resources). In one example, the signal S2 consists of N UL transmissions from the UE, and UL transmission i includes information (e.g., presence of UL transmission j and/or payload size and/or modulation coding scheme and/or resources) about UL transmission j, where j>i.

In one example, the signal S2 consist of multiple (e.g., N, where N>1) UL transmissions from the UE. In one example, in response to UL transmission i, the network transmits a signal or channel providing an acknowledgement. In one example, in response to UL transmission i, the network transmits a signal or channel providing an acknowledgement, and the acknowledgement includes information (e.g., presence of UL transmission j and/or payload size and/or modulation coding scheme and/or resources) about UL transmission j, where j 22 i.

In one example, an UL transmission can be a random access preamble signal. In one example, an UL transmission can be a random access preamble signal followed by a subsequent UL transmission, e.g., physical uplink shared channel (PUSCH) transmission. In one example, an UL transmission can be a random access preamble signal, and if the UE receives an acknowledgement (e.g., random access response), the UE can transmit a subsequent UL transmission, e.g., a physical uplink shared channel (PUSCH). In one example, an UL transmission can be a random access preamble signal, and if the UE receives an acknowledgement (e.g., random access response), the acknowledgment provides information about a subsequent UL transmission from and UE (e.g., presence of the subsequent UL transmission and/or payload size and/or modulation coding scheme and/or resources), and if subsequent UL transmission is present, the

UE can transmit the subsequent UL transmission. In one example, the subsequent UL response can be a PUCCH. In one example, the subsequent UL response can be a SRS. In one example, the subsequent UL response can be a PRACH. In one example, the subsequent UL response can be an OOK signal.

In one example, an UL transmission can be an on-off-keying (OOK) signal or WUS or LP WUS. In one example, an UL transmission can be an OOK signal followed by a subsequent UL transmission, e.g., physical uplink shared channel (PUSCH) transmission. In one example, an UL transmission can be an OOK signal, and if the UE receives an acknowledgement (e.g., OOK response), the UE can transmit a subsequent UL transmission, e.g., a physical uplink shared channel (PUSCH). In one example, an UL transmission can be an OOK signal, and if the UE receives an acknowledgement (e.g., OOK response), the acknowledgment provides information about a subsequent UL transmission from and UE (e.g., presence of the subsequent UL transmission and/or payload size and/or modulation coding scheme and/or resources), and if subsequent UL transmission is present, the UE can transmit the subsequent UL transmission. In one example, the subsequent UL response can be a PUCCH. In one example, the subsequent UL response can be a SRS. In one example, the subsequent UL response can be a PRACH. In one example, the subsequent UL response can be an OOK signal.

In one example, an UL transmission can be physical uplink control channel (PUCCH). In one example, an UL transmission can be a PUCCH followed by a subsequent UL transmission, e.g., physical uplink shared channel (PUSCH) transmission. In one example, an UL transmission can be a PUCCH signal, and if the UE receives an acknowledgement (e.g., PUCCH response), the UE can transmit a subsequent UL transmission, e.g., a physical uplink shared channel (PUSCH). In one example, an UL transmission can be a PUCCH, and if the UE receives an acknowledgement (e.g., PUCCH response), the acknowledgment provides information about a subsequent UL transmission from and UE (e.g., presence of the subsequent UL transmission and/or payload size and/or modulation coding scheme and/or resources), and if subsequent UL transmission is present, the UE can transmit the subsequent UL transmission. In one example, the subsequent UL response can be a PUCCH. In one example, the subsequent UL response can be a SRS. In one example, the subsequent UL response can be a PRACH. In one example, the subsequent UL response can be an OOK signal.

In one example, an UL transmission can be sounding reference signal (SRS). In one example, an UL transmission can be a SRS followed by a subsequent UL transmission, e.g., physical uplink shared channel (PUSCH) transmission. In one example, an UL transmission can be a SRS signal, and if the UE receives an acknowledgement (e.g., SRS response), the UE can transmit a subsequent UL transmission, e.g., a physical uplink shared channel (PUSCH). In one example, an UL transmission can be a SRS, and if the UE receives an acknowledgement (e.g., SRS response), the acknowledgment provides information about a subsequent UL transmission from and UE (e.g., presence of the subsequent UL transmission and/or payload size and/or modulation coding scheme and/or resources), and if subsequent UL transmission is present, the UE can transmit the subsequent UL transmission. In one example, the subsequent UL response can be a PUCCH. In one example, the subsequent UL response can be a SRS. In one example, the subsequent UL response can be a PRACH. In one example, the subsequent UL response can be an OOK signal.

In one example, an UL transmission can be a first PUSCH. In one example, an UL transmission can be a first PUSCH followed by a subsequent UL transmission, e.g., second physical uplink shared channel (PUSCH) transmission. In one example, an UL transmission can be a first PUSCH, and if the UE receives an acknowledgement (e.g., first PUSCH response), the UE can transmit a subsequent UL transmission, e.g., a second physical uplink shared channel

(PUSCH). In one example, an UL transmission can be a first PUSCH, and if the UE receives an acknowledgement (e.g., first PUSCH response), the acknowledgment provides information about a subsequent UL transmission from and UE (e.g., presence of the subsequent UL transmission and/or payload size and/or modulation coding scheme and/or resources), and if subsequent UL transmission is present, the UE can transmit the subsequent UL transmission. In one example, the subsequent UL response can be a PUCCH. In one example, the subsequent UL response can be a SRS. In one example, the subsequent UL response can be a PRACH. In one example, the subsequent UL response can be an OOK signal.

In one example, an UL transmission can be a walk up signal (WUS) or low power WUS (LP-WUS). In one example, the WUS can be transmitted by a low power radio in the UE. In one example, the UE has a low power radio and a main radio. In one example, the WUS can be transmitted by the main radio in the UE. In one example, the UE has a main radio but no low power radio. In one example, the WUS or LP-WUS is received by a low power receiver or radio in the base station, wherein the low power receiver or radio can wake up the main radio in the base station. In one example, the WUS or LP-WUS is received by a main radio in the base station. In one example, an UL transmission can be a WUS or LP-WUS followed by a subsequent UL transmission, e.g., physical uplink shared channel (PUSCH) transmission, in one example, the PUSCH transmission can be transmitted by the main radio, in one example, the PUSCH transmission can be transmitted by the low power radio. In one example, the PUSCH is received by the main radio in the base station. In one example, an UL transmission can be a WUS or LP-WUS, and if the UE receives an acknowledgement (e.g., WUS response), the UE can transmit a subsequent UL transmission, e.g., a physical uplink shared channel (PUSCH), in one example, the PUSCH transmission can be transmitted by the main radio, in one example, the PUSCH transmission can be transmitted by the low power radio. In one example, the PUSCH is received by the main radio in the base station. In one example, an UL transmission can be a WUS or LP-WUS, and if the UE receives an acknowledgement (e.g., WUS response), the acknowledgment provides information about a subsequent UL transmission from and UE (e.g., presence of the subsequent UL transmission and/or payload size and/or modulation coding scheme and/or resources), and if subsequent UL transmission is present, the UE can transmit the subsequent UL transmission, in one example, the subsequent UL transmission can be transmitted by the main radio, in one example, the subsequent UL transmission can be transmitted by the low power radio. In one example, the PUSCH is received by the main radio in the base station. In one example, the WUS or LP-WUS or the PUSCH or the subsequent UL transmission can be received by a low power radio in the gNB. In one example, the WUS or LP-WUS or the PUSCH or the subsequent UL transmission can be received by a main power radio in the gNB. In one example, the response to the WUS or LP-WUS can be transmitted by a low power radio in the gNB. In one example, the response to the WUS or LP-WUS can be transmitted by a main power radio in the gNB. In one example, the response to the WUS or LP-WUS can be received by a low power radio in the UE. In one example, the response to the WUS or LP-WUS can be received by a main power radio in the UE. In one example, the gNB has a low power radio and a main radio. In one example, the gNB has a main radio but no low power radio. In one example, the subsequent UL response can be a PUCCH. In one example, the subsequent UL response can be a SRS. In one example, the subsequent UL response can be a PRACH. In one example, the subsequent UL response can be an OOK signal.

In the previous examples, the random access preamble or OOK signal or PUCCH or SRS or first PUSCH or WUS or LP-WUS signal can be replaced by one or more of:
Reference signal
Reference signal scrambled by a UE specific identity
UL control channel
UL control channel that includes a UE specific identity
UL shared channel
UL shared channel that includes a UE specific identity

In one example, the timing of the S2 transmission is relative to the S1 signal. In one example, the timing of the S2 transmission is provided by the S1 signal, for example, this can be a timing offset relative to S1.

In one example, the S1 signal includes multiple synchronization signal indices, referred to as S1 indices, a UE selects a S1 index based on:
The S1 index with the largest RSRP.
The S1 index with the largest SINR.
A S1 index with an RSRP above a threshold, wherein the threshold can be provided by the system information included or associated with S1.

A S1 index with an SINR above a threshold, wherein the threshold can be provided by the system information included or associated with S1.

In one example, the timing of the S2 transmission is relative to the selected S1 signal index. In one example, the timing of the S1 transmission is provided by the S1 signal, for example, this can be a timing offset relative to selected S1 index, and/or depends on the selected S1 index.

In one example, S2 is transmitted in the same frequency band or carrier frequency as S1. In one example, the starting RB (or sub-carrier) and/or the number of RBs (or sub-carriers) of S2 is included in the system information associated with S1. In one example, the starting RB (or sub-carrier) and/or the number of RBs (or sub-carriers) of S2 can depend on a selected S1 index. In one example, the number of RBs (or sub-carriers) of S2 is defined in the system specifications. In one example, a target reception power of S2 is indicated in the system information associated with S1. In one example, a maximum number of transmissions for S2, e.g., for which the UE may not receive an acknowledgement is indicated in the system information associated with S1.

In one example, S2 is transmitted in the same frequency band or carrier frequency as S3. In one example, the starting RB (or sub-carrier) and/or the number of RBs (or sub-carriers) of S2 is included in the system information associated with S1. In one example, the starting RB (or sub-carrier) and/or the number of RBs (or sub-carriers) of S2 can depend on a selected S1 index. In one example, the number of RBs (or sub-carriers) of S2 is defined in the system specifications. In one example, a target reception power of S2 is indicated in the system information associated with S1. In one example, a maximum number of transmissions for S2, e.g., for which the UE may not receive an acknowledgement is indicated in the system information associated with S1.

In one example, S2 is transmitted in a frequency band or carrier frequency included in the system information associated with S1. In one example, the starting RB (or sub-carrier) and/or the number of RBs (or sub-carriers) of S2 is included in the system information associated with S1. In one example, the starting RB (or sub-carrier) and/or the number of RBs (or sub-carriers) of S2 can depend on a selected S1 index. In one example, the number of RBs (or sub-carriers) of S2 is defined in the system specifications. In one example, a target reception power of S2 is indicated in the system information associated with S1. In one example, a maximum number of transmissions for S2, e.g., for which the UE may not receive an acknowledgement is indicated in the system information associated with S1.

In one example, the content of S2 signal from the UE to the network can include one or more of the following information:
Information related to the position of the UE.
Information related to RSRP or SINR measurements of S1 signal. This can include measurements form cell used to determine S2 as well measurements of S1 from neighboring cells. This can include S1 indices and corresponding RSRP or SINR measurement. In one example, measurements of RSRP or SINR that exceed a threshold are provided. In one example, up to N measurements RSRP or SINR are provided. In one example, measurement of RSRP or SINR from up to M cells are provided. In one example, the threshold or N or M are provided in the system information associated with S1.
Information related to the UE capability.
Information related to traffic (or data) to be provided by the UE, such as amount of data, data throughput, latency requirements, QoS requirements, etc

FIG. 20 illustrates example signal transmissions 2000 in a wireless communication system according to embodiments of the present disclosure. For example, signal transmissions 2000 can be implemented by gNB 102, and any of the UEs 111-116. This example is for illustration only and other embodiments can be used without departing from the scope of the present disclosure.

As illustrated in FIG. 20, in one example, S1 and S3 are transmitted from a same TRP or base station or from TRPs located in close proximity to each other.

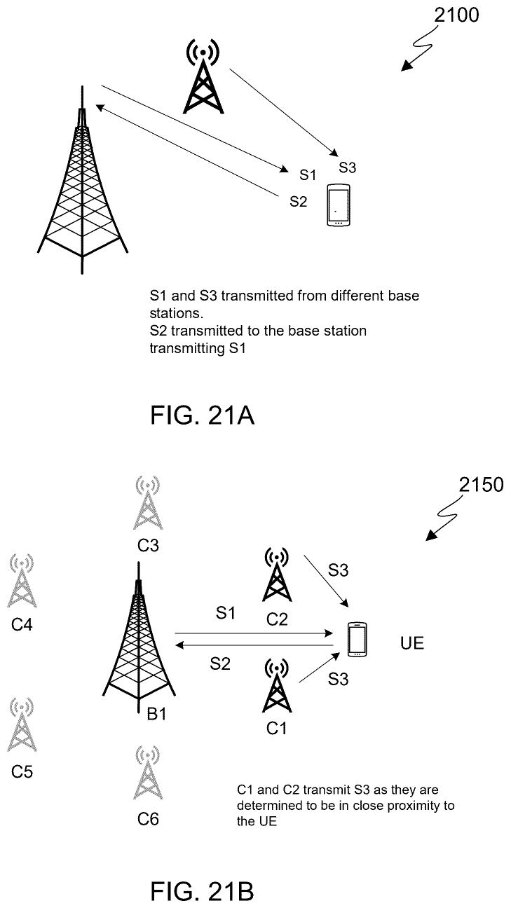

FIG. 21A and FIG. 21B illustrate example signal transmissions 2100 and 2150, respectively, in a wireless communication system according to embodiments of the present disclosure. For example, signal transmissions 2100 and 2150 can each be implemented by one or more gNB 102, and any of the UEs 111-116. These examples are for illustration only and other embodiments can be used without departing from the scope of the present disclosure.

In one example, S1 and S3 are transmitted from different TRPs or different base stations. As illustrated in FIG. 21A, S2 is transmitted to the same TRP or base station as that transmitting S1. In one example, S1 is transmitted from a first base station. The UE transmits signal S2 to the first base station, based on S2, the first base station and the second base station exchange information to decide on the S3 signal to be transmitted from the second base station. In one example, S1 can include information about the timing and/or structure of S3. In one example, the UE can receive S1 to get the timing information about S3. The UE receives S3 for initial beam acquisition on the second base station.

As illustrated in FIG. 21B, in one example, a coverage area is covered by one base station, e.g., B1, for carrier frequency 1 (e.g., in FR1) and multiple base stations, e.g., C1, C2, . . . for carrier frequency 2 (e.g., FR2 or FR3). The UE sends the signal S2 on FR1 to base station B1. Based on information acquired from signal S2, the network can activate or configure the base station(s) that is/are in close proximity to the UE on carrier frequency 2 to transmit S3 as illustrated in FIG. 21B.

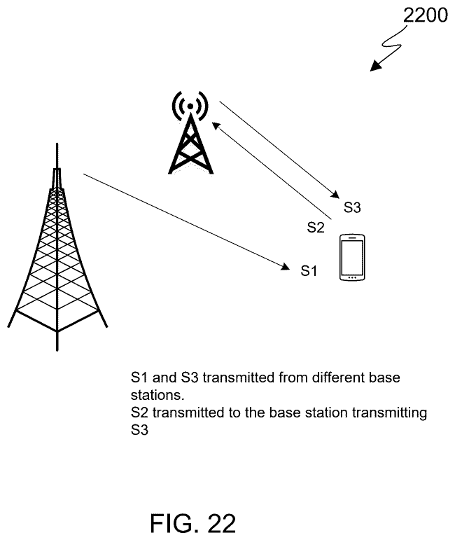

FIG. 22 illustrates example signal transmissions 2200 in a wireless communication system according to embodiments of the present disclosure. For example, signal transmissions 2200 can be implemented by one or more gNB, and any of the UEs 111-116. This example is for illustration only and other embodiments can be used without departing from the scope of the present disclosure.

In one example, S1 and S3 are transmitted from different TRPs or different base stations. As illustrated in FIG. 22, S2 is transmitted to the same TRP or base station as that transmitting S3. In one example, S1 is transmitted from a first base station. The system information associated with S1 can provide information about receive windows for second base station for S2. The UE transmits signal S2 to the second base station, based on S2, the second base station transmits S3. In one example, S1 can include information about the timing and/or structure and/or frequency information of S3 and/or S2. The UE receives S3 for initial beam acquisition.

In one example to acquire the beam on carrier frequency 2 (e.g., in FR2 or FR3), a UE can:
Identify an S3 index. In one example, the S3 index is the S3 index with the largest RSRP or SINR. In one example, the S3 index is an S3 index that exceeds a threshold. In one example, the threshold is provided by the system information associated with S1. In one example, the threshold is provided by the system information associated with S3.
Based on the selected S3 index, identify or select an UL transmission associated with the S3 index. In one example, the UL transmission can be a PRACH preamble (or OOK+PRACH). In one example, the UL transmission is a PRACH preamble and a PUSCH transmission. In one example, the UL transmission is a SRS (or PRACH+SRS or OOK (WUS or LP-WUS)+SRS). In one example, the UL transmission is a PUCCH (or PRACH+PUCCH or OOK (WUS or LP-WUS)+PUCCH). In one example, the UL transmission is a PUSCH (or PRACH+PUSCH or OOK (WUS or LP-WUS)+PUSCH). In one example, the UL transmission is a walk up signal (WUS) or LP-WUS. In one example, the UL transmission is an OOK signal (or PRACH+OOK). In one example, association information between the S3 index and the UL transmission resource/occasion is provided by system information associated with S1. In one example, association information between the S3 index and the UL transmission resource/occasion is provided by system information associated with S3. In one example, the UL transmission resource/occasion is a PRACH preamble and associated PRACH occasion.
In one example, the beam associated with the selected S3 index, and the beam associated with the UL signal transmission (e.g., PRACH preamble, or UL transmission following PRACH preamble) are the corresponding DL and UL beams used for subsequent DL receptions/transmissions and UL transmissions/receptions on carrier frequency 2. The beams are used until a new spatial domain filter or beam, or TCI state or spatial relation is configured or activated or indicated to the UE for DL and UL transmissions respectively.

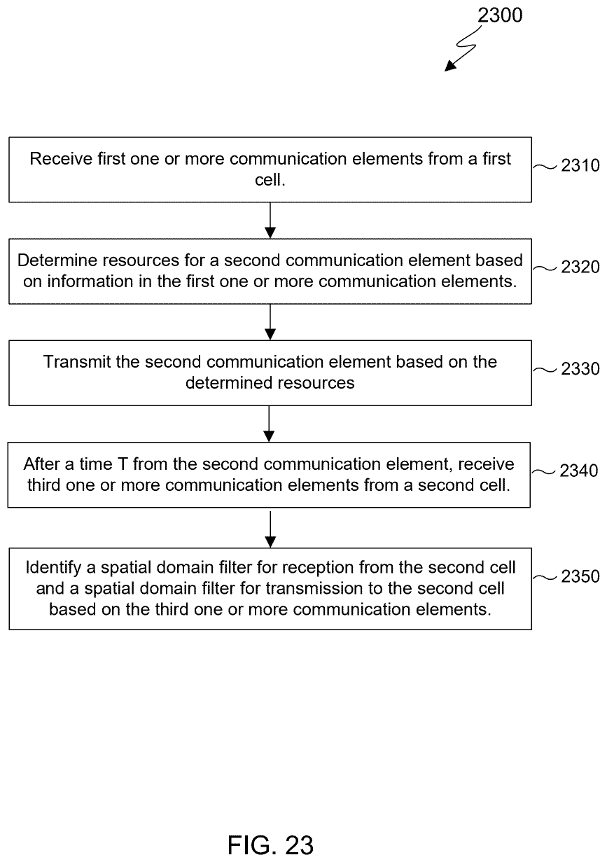

FIG. 23 illustrates an example method 2300 performed by a UE in a wireless communication system according to embodiments of the present disclosure. The method 2300 of FIG. 23 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2300 is for illustration only and other embodiments can be used without departing from the scope of the present disclosure.

The method 2300 begins with the UE receiving first one or more communication elements from a first cell (2310). The UE then determines resources for a second communication element based on information in the first one or more communication elements (2320). The UE then transmits the second communication element based on the determined resources (2330). In various embodiments, the second communication element is a PRACH.

The UE then, after a time T from the second communication element, receives third one or more communication elements from a second cell (2340). For example, in 2340, the third one or more communication elements and the time T are based on information from the first cell. In various embodiments, the reception of the third one or more communication elements is based on information in the first one or more communication elements. In various embodiments, the third one or more communication elements is a CSI-RS. In various embodiments, reception from the first cell is based a first carrier frequency and reception from the second cell is based a second carrier frequency. In various embodiments, the second communication element is transmitted to the second cell operating in a second carrier frequency.

The UE then identifies a spatial domain filter for reception from the second cell and a spatial domain filter for transmission to the second cell based on the third one or more communication elements (2350). In various embodiments, the second communication element is transmitted to the first cell operating in a first carrier frequency, the UE receives fourth one or more communication elements from the first cell, and the reception of the third one or more communication elements is based on information in the fourth one or more communication elements.

Any of the above variation embodiments can be utilized independently or in combination with at least one other variation embodiment. Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive first one or more communication elements from a first cell; and
a processor operably coupled to the transceiver, the processor configured to determine resources for a second communication element based on information in the first one or more communication elements,
wherein the transceiver is further configured to:
transmit the second communication element based on the determined resources, and
receive, after a time T from the second communication element, third one or more communication elements from a second cell,
wherein the third one or more communication elements and the time T are based on information from the first cell, and
wherein the processor is further configured to identify a spatial domain filter for reception from the second cell and a spatial domain filter for transmission to the second cell based on the third one or more communication elements.

2. The UE of claim 1, wherein:
reception from the first cell is based a first carrier frequency, and
reception from the second cell is based a second carrier frequency.

3. The UE of claim 1, wherein the reception of the third one or more communication elements is based on information in the first one or more communication elements.

4. The UE of claim 1, wherein the second communication element is transmitted to the second cell operating in a second carrier frequency.

5. The UE of claim 1, wherein:
the second communication element is transmitted to the first cell operating in a first carrier frequency,
the transceiver is further configured to receive fourth one or more communication elements from the first cell, and
the reception of the third one or more communication elements is based on information in the fourth one or more communication elements.

6. The UE of claim 1, wherein the second communication element is a physical random access channel (PRACH).

7. The UE of claim 1, wherein the third one or more communication elements is a channel state information reference signal (CSI-RS).

8. A base station (BS), comprising:
a transceiver configured to:
transmit first one or more communication elements from a first cell, wherein the first one or more communication elements include information about a second communication element and a time T, and
receive the second communication element; and
a processor operably coupled to the transceiver, the processor configured to determine resources for third one or more communication elements, from a second cell, based on information in the second communication element,
wherein the transceiver is further configured to transmit, based on the determined resources, the third one or more communication elements the time T from the second communication.

9. The BS of claim 8, wherein:
transmission on the first cell is based a first carrier frequency, and
transmission on the second cell is based a second carrier frequency.

10. The BS of claim 8, wherein the first cell and the second cell are not geographically co-located.

11. The BS of claim 8, wherein the first one or more communication elements include information on the resources of the third one or more communication elements.

12. The BS of claim 8, wherein the second communication element is received on the second cell operating in a second carrier frequency.

13. The BS of claim 8, wherein:
the second communication element is received on the first cell operating in a first carrier frequency,
the transceiver is further configured to transmit fourth one or more communication elements from the first cell, and
the fourth one or more communication elements include information about the second one or more communication elements.

14. The BS of claim 8, wherein the third one or more communication elements is a channel state information reference signal (CSI-RS).

15. A method of operating a user equipment (UE), the method comprising:
receiving first one or more communication elements from a first cell;
determining resources for a second communication element based on information in the first one or more communication elements;
transmitting the second communication element based on the determined resources;
receiving, after a time T from the second communication element, third one or more communication elements from a second cell, wherein the third one or more communication elements and the time T are based on information from the first cell; and
identifying a spatial domain filter for reception from the second cell and a spatial domain filter for transmission to the second cell based on the third one or more communication elements.

16. The method of claim 15, wherein the reception of the third one or more communication elements is based on information in the first one or more communication elements.

17. The method of claim 15, wherein the second communication element is transmitted to the second cell operating in a second carrier frequency.

18. The method of claim 15, wherein:
the second communication element is transmitted to the first cell operating in a first carrier frequency, the method further comprises receiving fourth one or more communication elements from
the first cell, and
the third one or more communication elements are based on information in the fourth one or more communication elements.

19. The method of claim 15, wherein the second communication element is a physical random access channel (PRACH).

20. The method of claim 15, wherein the third one or more communication elements is a channel state information reference signal (CSI-RS).
